(19) United States
(12) Patent Application Publication
(10) Pub. No.: US 2024/0046805 A1
(43) Pub. Date: Feb. 8, 2024

(54) METHOD OF DETERMINING CLOUD BASE USING METEOROLOGICAL OBSERVATION IN AIRCRAFT AND SYSTEM FOR DETERMINING CLOUD BASE

(71) Applicant: NATIONAL INSTITUTE OF METEOROLOGICAL SCIENCES, Jeju-do (KR)

(72) Inventors: Woonseon JUNG, Jeju-do (KR); Ki-Ho CHANG, Seoul (KR); Jung Mo KU, Jeju-do (KR); Yong Hee LEE, Seoul (KR)

(21) Appl. No.: 18/059,305

(22) Filed: Nov. 28, 2022

(30) Foreign Application Priority Data
Aug. 4, 2022 (KR) 10-2022-0097129

(51) Int. Cl. G08G 5/00; G05D 1/04

(52) U.S. Cl. CPC G08G 5/0091; G08G 5/0039; G05D 1/042

(57) ABSTRACT

A method of determining a cloud base through meteorological observation of an atmospheric research aircraft is provided. The method may include collecting meteorological observation information by performing meteorological observation while the atmospheric research aircraft changes a flight altitude, determining a flight altitude that satisfies a plurality of conditions by using the collected meteorological observation information, and determining the determined flight altitude to be a cloud base height. The plurality of conditions may include a first condition in which a liquid water content (LWC) is greater than a first threshold, a second condition in which relative humidity increases or decreases, and a third condition in which a cloud droplet number concentration is greater than a second threshold.

### CROSS-REFERENCE TO RELATED APPLICATION

This application claims the benefit of Korean Patent Application No. 10-2022-0097129 filed on Aug. 4, 2022, in the Korean Intellectual Property Office, the entire disclosure of which is incorporated herein by reference for all purposes.

### BACKGROUND

### 1. Field of the Invention

The following disclosure relates to a method of determining a cloud base using meteorological observation in an atmospheric research aircraft and a system for determining a cloud base.

### 2. Description of the Related Art

A cloud top may be observed using a satellite. A vertical profile of humidity may be observed through a radiosonde, and a cloud base may be estimated by using the vertical profile of humidity. However, the accuracy of such estimation may not be high.

The above description is information the inventor(s) acquired during the course of conceiving the present disclosure, or already possessed at the time, and is not necessarily art publicly known before the present application was filed.

### SUMMARY

According to an aspect, there is provided a method of determining a cloud base through meteorological observation of an atmospheric research aircraft including collecting meteorological observation information by performing meteorological observation while the atmospheric research aircraft changes a flight altitude, determining a flight altitude that satisfies a plurality of conditions by using the collected meteorological observation information, and determining the determined flight altitude to be a cloud base height.

The plurality of conditions may include a first condition in which a liquid water content (LWC) is greater than a first threshold, a second condition in which relative humidity increases or decreases, and a third condition in which a cloud droplet number concentration is greater than a second threshold.

The plurality of conditions may further include a fourth condition in which a cloud droplet particle appears on an image of the collected meteorological observation information.

The atmospheric research aircraft may change a flight altitude by flying from under a cloud base to inside a cloud or flying from inside the cloud to under the cloud base.

The collecting may include collecting the meteorological observation information while the atmospheric research aircraft flies from under a cloud base to inside a cloud. The determining of the cloud base height may include determining the cloud base height to be a flight altitude that firstly satisfies the first condition, the second condition, and the third condition.

The collecting may include collecting the meteorological observation information while the atmospheric research aircraft flies from inside a cloud to under a cloud base. The determining of the cloud base height may include determining the cloud base height to be a flight altitude that lastly satisfies the first condition, the second condition, and the third condition.

The first threshold and the second threshold may be equal to 0.

According to an aspect, there is provided a cloud base determination system including an atmospheric research aircraft, observation equipment mounted on the atmospheric research aircraft and configured to collect meteorological observation information by performing meteorological observation while the atmospheric research aircraft changes a flight altitude, and a computing device configured to determine a flight altitude that satisfies a plurality of conditions by using the collected meteorological observation information and determine a cloud base height based on the determined flight altitude.

The plurality of conditions may include a first condition in which an LWC is greater than a first threshold, a second condition in which relative humidity increases or decreases, and a third condition in which a cloud droplet number concentration is greater than a second threshold.

The plurality of conditions may further include a fourth condition in which a cloud droplet particle appears on an image of the collected meteorological observation information.

The atmospheric research aircraft may change a flight altitude by flying from under a cloud base to inside a cloud or flying from inside the cloud to under the cloud base.

The observation equipment may be configured to collect the meteorological observation information while the atmospheric research aircraft flies from a cloud base to inside a cloud. The computing device may be configured to determine the cloud base height to be a flight altitude that firstly satisfies the first condition, the second condition, and the third condition.

The observation equipment may be configured to collect the meteorological observation information while the atmospheric research aircraft flies from inside a cloud to under a cloud base. The computing device may be configured to determine the cloud base height to be a flight altitude that lastly satisfies the first condition, the second condition, and the third condition.

The first threshold and the second threshold may be equal to 0.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIGS. 1 and 2 are diagrams schematically illustrating an example of determining a cloud base using meteorological observation of an atmospheric research aircraft, according to one embodiment;

FIG. 3 is a block diagram illustrating a system for determining a cloud base according to one embodiment;

FIGS. 4A to 4D are diagrams illustrating an example of meteorological observation information according to one embodiment;

FIG. 5 is a flowchart illustrating a method of determining a cloud base, according to one embodiment; and

FIG. 6 is a flowchart illustrating a method of determining a cloud base, according to one embodiment.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings. When describing the embodiments with reference to the accompanying drawings, like reference numerals refer to like components and a repeated description related thereto will be omitted.

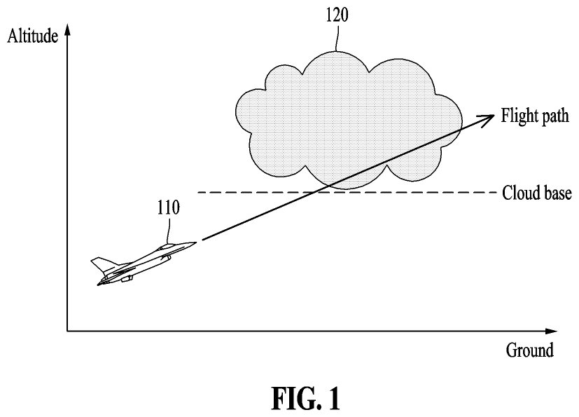

FIGS. 1 and 2 are diagrams schematically illustrating an example of determining a cloud base using meteorological observation of an atmospheric research aircraft, according to one embodiment.

Referring to FIGS. 1 and 2, an atmospheric research aircraft 110 and a cloud 120 are illustrated.

The atmospheric research aircraft 110 may be a manned atmospheric research aircraft or an unmanned atmospheric research aircraft.

As illustrated in FIG. 1, the atmospheric research aircraft 110 may fly from the cloud base to inside a cloud (or cloud penetration).

The atmospheric research aircraft 110 may collect meteorological observation information by performing meteorological observation while flying from the cloud base to inside the cloud. The meteorological observation information may include, for example, any one or any combination of liquid water content (LWC), relative humidity, a cloud droplet number concentration (or cloud droplet concentration), or a particle image.

The atmospheric research aircraft 110 may determine a cloud base (or a cloud base height) using the collected meteorological observation information. In one embodiment, the atmospheric research aircraft 110 may determine a flight altitude that satisfies various conditions by using the collected meteorological observation information. The conditions may include, for example, a condition 1 in which an LWC is greater than a first threshold (e.g., “0”), a condition 2-1 in which relative humidity increases, and a condition 3 in which a cloud droplet number concentration is greater than a second threshold (e.g., “0”). According to an embodiment, the conditions may further include a condition 4 in which a cloud droplet appears on a particle image. The atmospheric research aircraft 110 may determine the cloud base height based on the determined flight altitude.

As illustrated in FIG. 2, the atmospheric research aircraft 110 may fly from inside the cloud to under the cloud base.

The atmospheric research aircraft 110 may collect meteorological observation information by performing meteorological observation while flying from inside the cloud to under the cloud base.

The atmospheric research aircraft 110 may determine the cloud base (or a cloud base height) using the collected meteorological observation information. In one embodiment, the atmospheric research aircraft 110 may determine a flight altitude that satisfies various conditions by using the collected meteorological observation information. The various conditions may include, for example, a condition 1 in which an LWC is greater than a first threshold (e.g., “0”), a condition 2-2 in which relative humidity decreases, and a condition 3 in which a cloud droplet number concentration is greater than a second threshold (e.g., “0”). According to an embodiment, the conditions may further include a condition 4 in which a cloud droplet appears on a particle image. The atmospheric research aircraft 110 may determine the cloud base height based on the determined flight altitude.

In one embodiment, accurate cloud base information (e.g., the cloud base height) may be obtained and the obtained cloud base information may be mainly used for an artificial rainfall experiment or a localized heavy rain monitoring. In addition, the obtained cloud base information may be used for take-off and landing of an airplane, and thus, may contribute to the safety of the airplane.

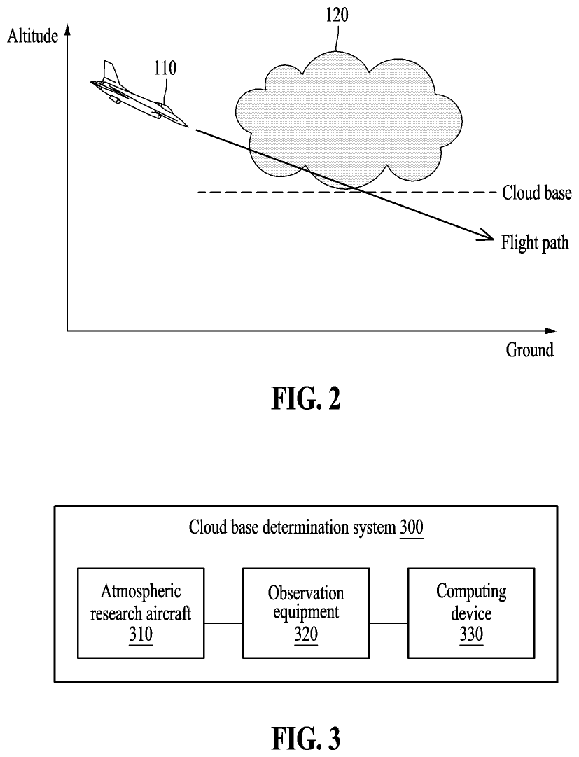

FIG. 3 is a block diagram illustrating a system for determining a cloud base according to one embodiment.

Referring to FIG. 3, a cloud base determination system 300 according to one embodiment may include an atmospheric research aircraft 310 (e.g., the atmospheric research aircraft 110 of FIG. 1), observation equipment (or observation instrument) 320, and a computing device 330.

The observation equipment 320 may be mounted on the atmospheric research aircraft 310.

The observation equipment 320 may include cloud physics observation equipment. The observation equipment 320 may include, for example, a cloud combination probe (CCP) including a cloud droplet probe (CDP) and a cloud imaging probe (CIP). For example, the CDP may observe a cloud droplet having a diameter of 2 μm to 50 μm and the CIP may observe a drizzle drop having a diameter of 7.5 μm to 930 μm.

The observation equipment 320 may include a humidity measuring instrument for measuring relative humidity. Depending on the implementation, the CCP may measure the relative humidity.

The observation equipment 320 may collect meteorological observation information (e.g., an LWC, relative humidity, a cloud droplet number concentration (or cloud droplet concentration), and a particle image) while an atmospheric research aircraft changes a flight altitude.

The computing device 330 may receive the meteorological observation information from the observation equipment 320. According to one embodiment, the computing device 330 may be mounted on the atmospheric research aircraft 310 or may be positioned on the ground.

The computing device 330 may determine a flight altitude that satisfies a plurality of conditions using the collected meteorological observation information. The conditions may include, for example, any one or any combination of the condition 1, the condition 2 (e.g., the condition 2-1 or the condition 2-2), the condition 3, and the condition 4, which are described above. The computing device 330 may determine a cloud base height based on the determined flight altitude.

In one embodiment, the computing device 330 may receive, from the observation equipment 320, the meteorological observation information collected while the atmospheric research aircraft 310 flies from under the cloud base to inside the cloud. The computing device 330 may determine the cloud base height to be a flight altitude that firstly satisfies the condition 1, the condition 2-1, and the condition 3. In other words, the computing device 330 may determine the cloud base height to be a flight altitude at which all the following cases have firstly occurred, which are the LWC is greater than the first threshold, the relative humidity increases, and the cloud droplet number concentration is greater than the second threshold.

For example, the computing device 330 may not determine the cloud base height to be a flight altitude h1 in case where the LWC at the flight altitude h1 of the atmospheric research aircraft is greater than the first threshold (e.g., there is liquid at the flight altitude h1) and the relative humidity increases around the flight altitude h1, but the cloud droplet number concentration at the flight altitude h1 corresponds to the second threshold (e.g., there is no cloud droplet number concentration at the flight altitude h1). In other words, since the flight altitude h1 does not satisfy all of the conditions (e.g., the condition 1, the condition 2-1, and the condition 3), the computing device 330 may not determine the flight altitude h1 to be the cloud base height.

For example, at a flight altitude h2, higher than the flight altitude h1, of the atmospheric research aircraft, the LWC may be greater than the first threshold, the relative humidity may increase around the flight altitude h2, and the cloud droplet number concentration at the flight altitude h2 may be greater than or equal to the second threshold. In this case, when the flight altitude h2 is a flight altitude that firstly satisfies all of the conditions (e.g., the condition 1, the condition 2-1, and the condition 3), the computing device 330 may determine the flight altitude h2 to be the cloud base height.

In one embodiment, the computing device 330 may receive, from the observation equipment 320, the meteorological observation information collected while the atmospheric research aircraft 310 flies from inside the cloud to under the cloud base.

The computing device 330 may determine the cloud base height to be a flight altitude that lastly satisfies the condition 1, the condition 2-2, and the condition 3. In other words, when the atmospheric research aircraft 310 flies inside the cloud, the condition 1, the condition 2-2, and the condition 3 may be satisfied at various flight altitudes, and when the atmospheric research aircraft 310 flies under the cloud base, at least one of the condition 1, the condition 2-2, and the condition 3 may be satisfied. Accordingly, among the flight altitudes satisfying the condition 1, the condition 2-2, and the condition 3, the lowest flight altitude (or the flight altitude that lastly satisfies the condition 1, the condition 2-2, and the condition 3) may be the cloud base height. Among flight altitudes satisfying the condition 1, the condition 2, and the condition 3, the computing device 330 may determine the last flight altitude (or the lowest flight altitude) to be the cloud base height.

For example, at a flight altitude ha of an atmospheric research aircraft, the LWC may be greater than the first threshold, the relative humidity may decrease around the flight altitude ha, and the cloud droplet number concentration at the flight altitude ha may be greater than the second threshold. At a flight altitude h_{b}, which is lower than the flight altitude hₐ, of the atmospheric research aircraft, the LWC may be greater than the first threshold, the relative humidity may decrease around the flight altitude h_{b}, and the cloud droplet number concentration at the flight altitude h_{b} may be greater than or equal to the second threshold. Since the conditions (e.g., the condition 1, the condition 2-2, and the condition 3) are satisfied at the flight altitude hb, which is lower than the flight altitude hₐ, the computing device 330 may determine that the flight altitude hₐ is not the cloud base height.

For example, at a flight altitude hc, which is lower than the flight altitude hb, of the atmospheric research aircraft, the LWC may correspond to the first threshold (e.g., there is no liquid at the flight altitude hc), the relative humidity may not change around the flight altitude hc, and the cloud droplet number concentration at the flight altitude hc may correspond to the second threshold. Since the conditions (e.g., the condition 1, the condition 2-2, and the condition 3) are satisfied at the flight altitude hb but the conditions (e.g., the condition 1, the condition 2-2, and the condition 3) are not satisfied at the flight altitude hc, the computing device 330 may determine that the flight altitude hb that lastly satisfies the conditions (e.g., the condition 1, the condition 2-2, and the condition 3) is the cloud base height.

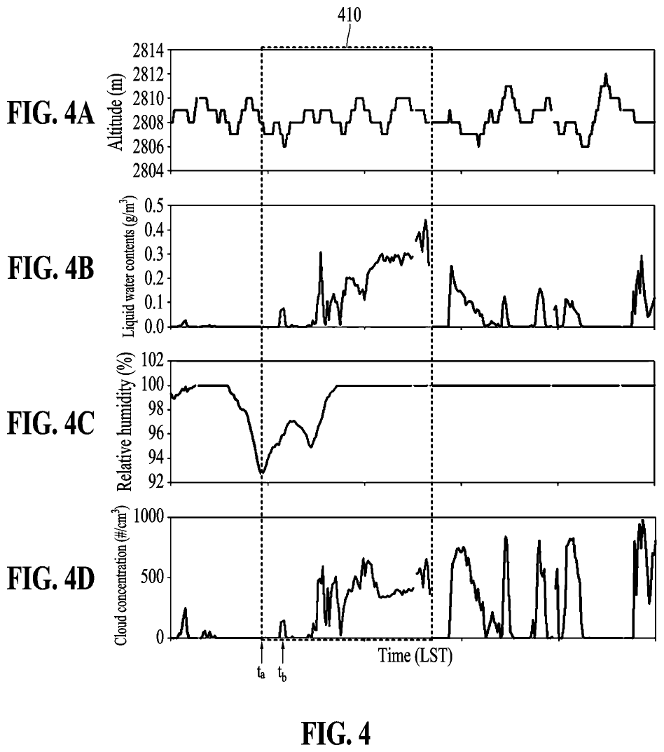

FIGS. 4A to 4D are diagrams illustrating an example of meteorological observation information according to one embodiment.

As illustrated in FIGS. 4A to 4D, FIG. 4A illustrates altitude information of the atmospheric research aircraft 310 over time, FIG. 4B illustrates an LWC over time, FIG. 4C illustrates relative humidity over time, and FIG. 4D illustrates a cloud droplet concentration over time.

Referring to FIGS. 4A to 4D, information 410 may represent altitude information and meteorological observation information while the atmospheric research aircraft 310 flies from under a cloud base to inside a cloud.

The computing device 330 may determine that at a time tₐ, an LWC corresponds to a first threshold (e.g., “0”), relative humidity does not increase around the time tₐ, and a cloud droplet number concentration corresponds to a second threshold (e.g., “0”) at the time tₐ. In other words, the computing device 330 may determine that there is no liquid at a flight altitude at the time tₐ, relative humidity does not increase around the flight altitude at the time tₐ, and there is no cloud droplet at the flight altitude at the time tₐ. In this case, the computing device 330 may determine that the flight altitude at the time tₐ is not the cloud base height.

The computing device 330 may determine that at a time t_{b}, an LWC is greater than the first threshold (e.g., “0”), relative humidity increases around the time t_{b}, and a cloud droplet number concentration is greater than the second threshold (e.g., “0”) at the time t_{b}. In other words, the computing device 330 may determine that there is liquid at a flight altitude at the time t_{b}, relative humidity increases around the flight altitude at the time t_{b}, and the cloud droplet number concentration is greater than 0 at the flight altitude at the time t_{b}. In this example, the computing device 330 may determine that the flight altitude at the time t_{b} is the cloud base height. In other words, since the flight altitude at the time t_{b} firstly satisfies all of the conditions (e.g., the condition 1, the condition 2-1, and the condition 3), the computing device 330 may determine that the flight altitude at the time t_{b} is the cloud base height.

According to an embodiment, to determine the cloud base height, the computing device 330 may determine whether a condition 4 is further satisfied. In other words, the computing device 330 may determine whether a cloud droplet appears on a particle image to determine the cloud base height. The cloud droplet concentration at the time t_{b} may correspond to the actual concentration of cloud droplets. However, the cloud droplet concentration at the time t_{b} may correspond to concentration of particles (e.g., a yellow dust particle, a dust particle, chaff, and the like), which are not the cloud droplet. To determine whether the cloud droplet concentration at the time t_{b} is based on cloud droplets or other particles than cloud droplets, the computing device 330 may analyze a particle image at the time t_{b}. For example, the computing device 330 may determine the shape and/or size of the cloud droplet. The computing device 330 may determine whether an object having the shape of the cloud droplet appears on the particle image at the time t_{b}. When the object having the shape of the cloud droplet appears on the particle image at the time t_{b}, the computing device 330 may determine that the cloud droplet actually exists at the flight altitude at the time t_{b}. Since the flight altitude at the time t_{b} firstly satisfies all of the conditions (e.g., the condition 1, the condition 2-1, the condition 3, and the condition 4), the computing device 330 may determine that the flight altitude at the time t_{b} is the cloud base height.

Unlike the embodiment described above, the condition 1, the condition 2-1, and the condition 3 may be satisfied at the flight altitude at the time t_{b}, however, the condition 4 may not be satisfied. In other words, at the flight altitude at the time t_{b}, liquid may exist, relative humidity may increase, and the cloud droplet number concentration is greater than 0, however, the cloud droplet may not be found in the particle image. In this case, the computing device 330 may not determine the cloud base height to be the flight altitude at the time t_{b}. The computing device 330 may find a flight altitude that firstly satisfies all conditions (e.g., the condition 1, the condition 2-1, the condition 3, and the condition 4) using the information 410 and the particle image, and may determine the found flight altitude to be the cloud base height.

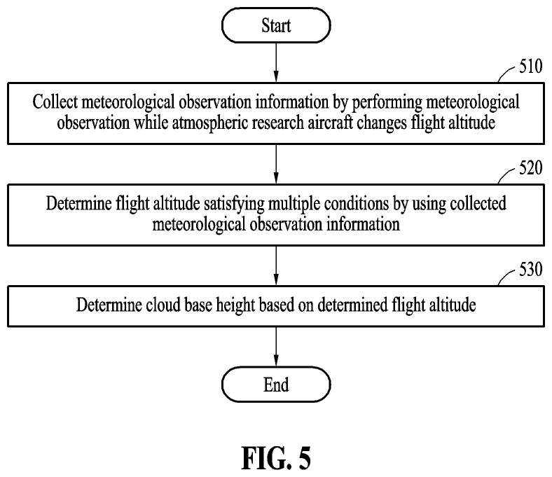

FIG. 5 is a flowchart illustrating a method of determining a cloud base according to one embodiment.

Referring to FIG. 5, in operation 510, the cloud base determination system 300 (or the observation equipment 320) may collect meteorological observation information by performing meteorological observation while the atmospheric research aircraft 310 changes a flight altitude.

In operation 520, the cloud base determination system 300 (or the computing device 330) may determine a flight altitude satisfying multiple conditions by using the collected meteorological observation information. The conditions may include, for example, any one or any combination of a condition 1 in which an LWC is greater than a first threshold, a condition 2 in which relative humidity increases or decreases, a condition 3 in which a cloud droplet number concentration is greater than a second threshold, and a condition 4 in which a cloud droplet appears on a particle image.

In operation 530, the cloud base determination system 300 (or the computing device 330) may determine a cloud base height based on the determined flight altitude.

The description provided with reference to FIGS. 1 to 4D also applies to the method of determining a cloud base of FIG. 5, and thus, a detailed description thereof is omitted for conciseness.

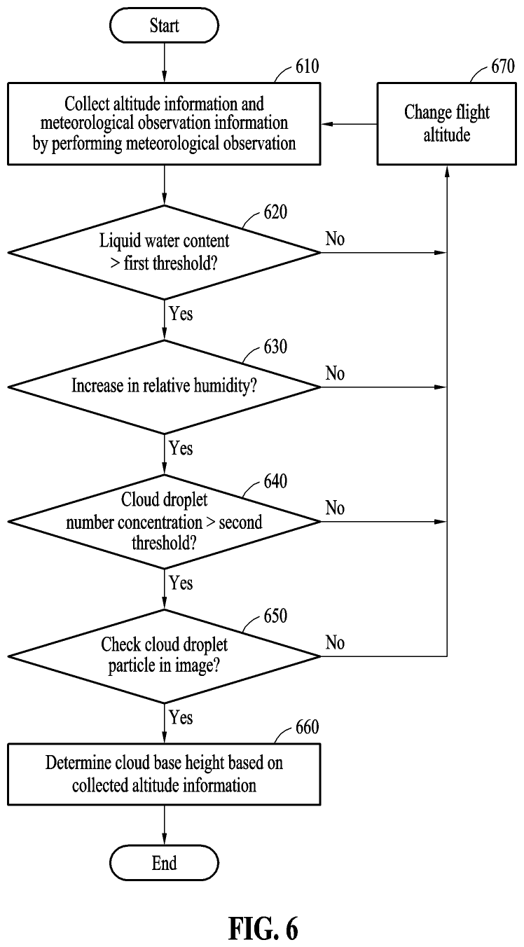

FIG. 6 is a flowchart illustrating a method of determining a cloud base, according to one embodiment.

Referring to FIG. 6, in operation 610, the cloud base determination system 300 (or the observation equipment 320) may collect altitude information and meteorological observation information by performing meteorological observation.

In operation 620, the cloud base determination system 300 (or the computing device 330) may determine whether an LWC is greater than a first threshold.

When the LWC is greater than the first threshold, in operation 630, the cloud base determination system 300 (or the computing device 330) may determine whether relative humidity increases.

When the relative humidity increases, in operation 640, the cloud base determination system 300 (or the computing device 330) may determine whether a cloud droplet number concentration is greater than a second threshold.

When the cloud droplet number concentration is greater than the second threshold, in operation 650, the cloud base determination system 300 (or the computing device 330) may check a cloud droplet particle in an image. For example, the cloud base determination system 300 (or the computing device 330) may determine whether the cloud droplet appears on a particle image.

When at least one cloud droplet particle appears on the image (e.g. when at least one cloud droplet appears on the particle image), in operation 660, the cloud base determination system 300 (or the computing device 330) may determine a cloud base height based on collected height information. For example, when the collected altitude height is a flight altitude h2, the cloud base determination system 300 (or the computing device 330) may determine the flight altitude h2 to be the cloud base height.

When the LWC corresponds to the first threshold, the relative humidity does not increase, the cloud droplet number concentration corresponds to the second threshold, or any cloud droplet particle does not appear on the image, in operation 670, the cloud base determination system 300 may change the flight altitude. At the changed flight altitude, the cloud base determination system 300 may perform operations 610 to 650.

The description provided with reference to FIGS. 1 to 5 also applies to the method of determining a cloud base of FIG. 6, and thus, a detailed description thereof is omitted for conciseness.

In the embodiment illustrated in FIG. 6, the order of operations 620 to 650 may change.

In the embodiment illustrated in FIG. 6, operations 620 to 650 may not be performed in a time series and may be performed independently or in parallel.

The examples described herein may be implemented using hardware components, software components and/or combinations thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or pseudo equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Therefore, other implementations, other example embodiments, and/or equivalents of the claims are within the scope of the following claims.

What is claimed is:

1. A method of determining a cloud base through meteorological observation of an atmospheric research aircraft, the method comprising:
collecting meteorological observation information by performing meteorological observation while the atmospheric research aircraft changes a flight altitude;
determining a flight altitude that satisfies a plurality of conditions by using the collected meteorological observation information; and
determining the determined flight altitude to be a cloud base height,
wherein the plurality of conditions comprises:
a first condition in which a liquid water content (LWC) is greater than a first threshold;
a second condition in which relative humidity increases or decreases; and
a third condition in which a cloud droplet number concentration is greater than a second threshold.

2. The method of claim 1, wherein the plurality of conditions further comprises a fourth condition in which a cloud droplet particle appears on an image of the collected meteorological observation information.

3. The method of claim 1, wherein the atmospheric research aircraft changes a flight altitude by flying from under a cloud base to inside a cloud or flying from inside the cloud to under the cloud base.

4. The method of claim 1, wherein the collecting comprises collecting the meteorological observation information while the atmospheric research aircraft flies from under a cloud base to inside a cloud, and
the determining of the cloud base height comprises determining the cloud base height to be a flight altitude that firstly satisfies the first condition, the second condition, and the third condition.

5. The method of claim 1, wherein the collecting comprises collecting the meteorological observation information while the atmospheric research aircraft flies from inside a cloud to under a cloud base, and
the determining of the cloud base height comprises determining the cloud base height to be a flight altitude that lastly satisfies the first condition, the second condition, and the third condition.

6. The method of claim 1, wherein the first threshold and the second threshold are equal to 0.

7. A cloud base determination system comprising:
an atmospheric research aircraft;
observation equipment mounted on the atmospheric research aircraft and configured to collect meteorological observation information by performing meteorological observation while the atmospheric research aircraft changes a flight altitude; and
a computing device configured to determine a flight altitude that satisfies a plurality of conditions by using the collected meteorological observation information and determine a cloud base height based on the determined flight altitude,
wherein the plurality of conditions comprises:
a first condition in which a liquid water content (LWC) is greater than a first threshold;
a second condition in which relative humidity increases or decreases; and
a third condition in which a cloud droplet number concentration is greater than a second threshold.

8. The cloud base determination system of claim 7, wherein the plurality of conditions further comprises a fourth condition in which a cloud droplet particle appears on an image of the collected meteorological observation information.

9. The cloud base determination system of claim 7, wherein the atmospheric research aircraft changes a flight altitude by flying from under a cloud base to inside a cloud or flying from inside the cloud to under the cloud base.

10. The cloud base determination system of claim 7, wherein the observation equipment is configured to collect the meteorological observation information while the atmospheric research aircraft flies from a cloud base to inside a cloud, and
the computing device is configured to determine the cloud base height to be a flight altitude that firstly satisfies the first condition, the second condition, and the third condition.

11. The cloud base determination system of claim 7, wherein the observation equipment is configured to collect the meteorological observation information while the atmospheric research aircraft flies from inside a cloud to under a cloud base, and
the computing device is configured to determine the cloud base height to be a flight altitude that lastly satisfies the first condition, the second condition, and the third condition.

12. The cloud base determination system of claim 9, wherein the first threshold and the second threshold are equal to 0.
